(19) United States
(12) Patent Application Publication
(10) Pub. No.: US 2014/0214479 A1
(43) Pub. Date: Jul. 31, 2014

(54) BEHAVIOR MANAGEMENT AND EXPENSE INSIGHT SYSTEM

(71) Applicants: Kevin A. Singel, Centennial, CO (US); Keith B. Elson, Ashburn, VA (US); Letica Fox Thomas, Staten Island, NY (US)

(72) Inventors: Kevin A. Singel, Centennial, CO (US); Keith B. Elson, Ashburn, VA (US); Letica Fox Thomas, Staten Island, NY (US)

(73) Assignee: Accenture Global Services Lmited, Dublin (IE)

(21) Appl. No.: 13/750,320

(22) Filed: Jan. 25, 2013

(51) Int. Cl. G06Q 30/02

(52) U.S. Cl. CPC G06Q 30/0201
USPC 705/7.29

(57) ABSTRACT

A behavior management and expense insight system stores user profiles, points of interest, and information for determining recommendations for the points of interest. An expense allowance module may compare an average amount spent for each point of interest by each user with a spending limit for each user, and determine an expense allowance indicator indicating whether an average amount spent is above, in par with, or below the spending limit for a geographic location for a user. A recommendation engine may determine a category of a point of interest in a request and select recommendations of points of interest for the request based on the category, the stored profile of the user, and the average amount spent for each stored point of interest in the category.

### BACKGROUND

A common scenario for a business traveler is that they have a per diem for travel expenses, such as food, drinks, lodging, etc. The per diem may specify a maximum amount they are allotted for their travel expenses by their company. The business traveler may select certain restaurants and lodging to fit their per diem. Also, restaurant and lodging selections may be made based on customer reviews. For example, websites for YELP and EXPEDIA provide customer reviews for restaurants and hotels, and the business traveler or anyone looking for recommendations may consult the reviews to select a restaurant or hotel. However, the customer reviews posted on these websites are made by random people that may generally describe how much the reviewer liked the food or discuss how friendly the staff was at a hotel. But this general information provided by random people may not always be pertinent to the needs of the company.

### BRIEF DESCRIPTION OF DRAWINGS

The embodiments are described in detail in the following description with reference to examples shown in the following figures.

FIG. 1 illustrates a behavior management and expense insight system.

FIG. 2 illustrates a system architecture for the system shown in FIG. 1.

FIG. 3 illustrates a computer system that may be a platform for the system shown in FIG. 1.

FIGS. 4A-C and 5-7 illustrate screenshots.

FIGS. 8-10 illustrate methods.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

According to an embodiment, a behavior management and expense insight system determines expense-related recommendations for users of a same organization based on information supplied by the users of the organization. The recommendations may be based on objectives of the organization and may be meant to influence expense-related, behavioral actions of the users to be commensurate with the organization's objectives, which may be business objectives of a company. The behavioral actions of the users or employees may include the selection and use of points of interest, which may be paid for by the company. The points of interest may be for restaurants, lodging, car service, etc. The points of interest may be services that are used by a person (restaurants, lodging, car service, etc.). These services may be paid for by the organization the person is working for or representing. For example, the services are paid for by an employee's company and the employee may be responsible for completing an expense report to indicate the services that were used that are considered business expenses and amount spent.

Also, the behavior management and expense insight system performs analytics to make predictions of the optimal points of interest to be used by the employee to further the company's business objectives based on the current circumstances of the employee and other factors. The predictions may be based on reviews, comments and other feedback generated by other employees in the company rather than random individuals that are unrelated to the company. The feedback may be filtered to identify feedback from peers or employees in the same department or category as the employee requesting the recommendations. This feedback is then used to make recommendations of the optimal points of interest to be used by the employee, which may be presented to the employee as targeted recommendations for that particular employee.

The recommendations may include additional detail to help the employee make the best selection for his or her use and the company's use. For example, restaurant recommendations may inform the employee, for each recommended restaurant, whether the average spend (e.g., after discount if one is available for the company) at each restaurant is above, on par with or below the spending limit for the person as set by his or her company, which may differ by geographic location.

Additionally, the behavior management and expense insight system is operable to more accurately capture expense information. For example, the system can capture comments with time and expense reports if the expenses are outside recommended spending limits, such as if an expense is for more than one employee or if the expense is for entertaining clients. The system can plot amount spent over time and provide an indication if it is above or on par with average amount spent for the area after time and expense reports are submitted. The system can collect total amount spent at each restaurant and use it for negotiating discounts with vendors. Reports are generated by the system that may describe overspending or spending in general by group or category, such as those with a client, project, team, performance level, company level (e.g. executive, consultant), engagement team, etc.

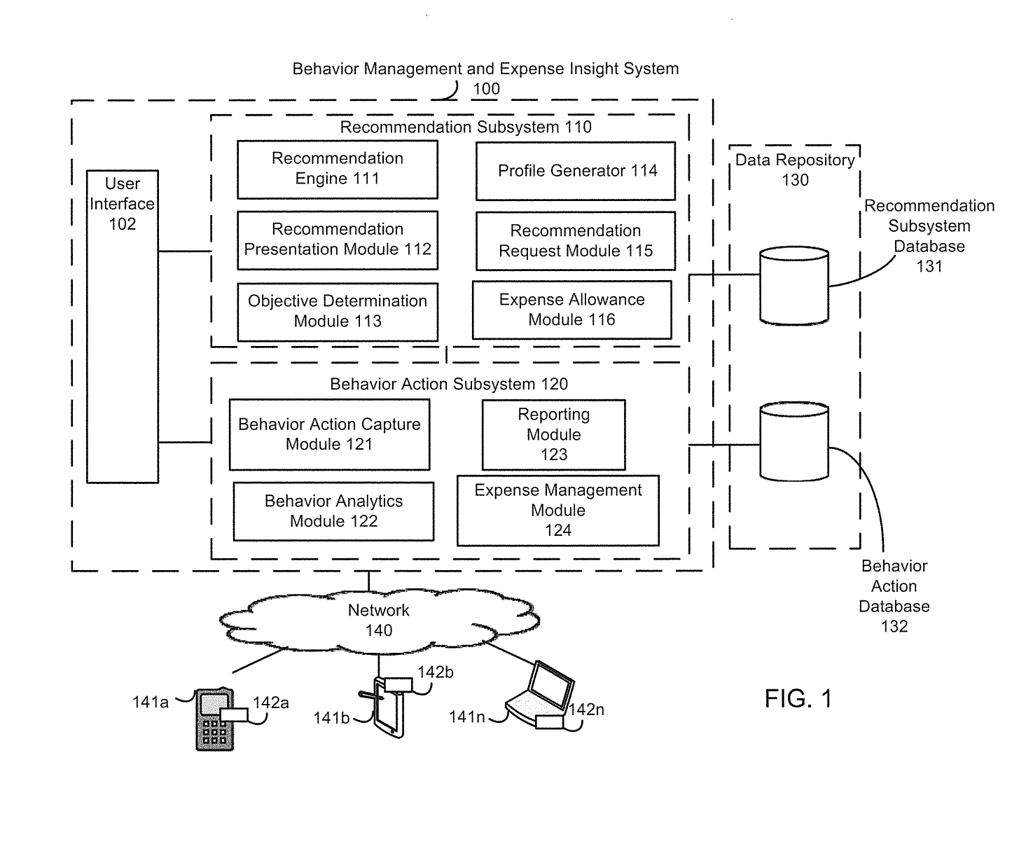

FIG. 1 illustrates the behavior management and expense insight system 100 according to an embodiment. The system 100 includes a recommendation subsystem 110 and a behavior action subsystem 120. The recommendation subsystem 110 for example includes a recommendation engine 111, a recommendation presentation module 112, an objective determination module 113, a profile generator 114, a recommendation request module 115, and an expense allowance module 116. The recommendation subsystem 110 may include a recommendation subsystem database 131 in a data repository 130 to store any data for the recommendation subsystem 110.

The recommendation subsystem 110 receives requests for recommendations from users and generates recommendations responsive to the requests. The recommendations may be for points of interest that are desired or may by desired by the user. The users may be employees or agents of an organization, such as a company or another type of organization that may be responsible for the users' expenses, and the points of interest may be paid for by the organization. The users may have user devices 141a-n that can send the requests to the system 100 via the network 140, and the recommendation subsystem 110 sends the recommendations to the user devices 141a-n via the network 140. The user devices 141a-n may include mobile devices, such as cellular phones, tablet computers, laptops, etc., or non-mobile devices, such as desktops or workstations. The user devices 141a-n may applications, shown as 142a-n, to interface with the system 100 and functionality for the system 100. The applications 142a-n may be executed on the user devices 142a-n so the users can input information for their recommendation requests and view recommendations, ratings, reviews and other related information generated by the system 100. Also, the applications 142a-n may be used to enter expense report information as is further described below.

The recommendation subsystem 110 determines profiles for the users and the profiles may be stored in the recommendation subsystem database 131 and used by the recommendation engine 111 to determine the recommendations. For example, the profile generator 114 determines and stores profiles for the users. The profile generator 114 may interface with other systems of a company to determine the profiles and may receive information from the users for the profiles. For example, an employee ID and other employee information may be retrieved from a human resources system of a company to generate a profile for a user. A user profile may include but is not limited to employee ID, employee name, age, gender, title (e.g., CEO, director, manager, sales representative, associate, etc.), company department (e.g., sales, research and development, information technology, etc.), employee category, job description, etc. The user profile may include user preferences received from the user, such as cuisine preferences, whether the user is vegetarian, whether the user drinks alcohol, hotel preferences, etc.

The recommendation request module 115 determines information about the current environment and circumstances of the user requesting recommendations, and this information may also be used by the recommendation engine 111 to determine the recommendations. For example, the recommendation request module 115 may determine the current geographic location of the user, the user ID, which may be their employee ID, category of desired points of interest (e.g., restaurant, bar, hotel, etc.), time and date of intended use of the desired points of interest, such as noon (e.g., for lunch). The recommendation request module 115 may request additional information from the user for the request, such as whether the user is by themselves or with other employees, whether the other employees are part of the user's team, are client's or potential clients going to be with the user and the name of the client and the client's company, and so on. The recommendation request module 115 may determine the objective of the meal and make recommendations based on the objective. For example, the information may identify that a project team will be at the restaurant and may make recommendations of restaurants that are mid-cost and have a lively atmosphere, as opposed to restaurants that may be better suited for meetings with individuals and that may have a more private and sophisticated atmosphere. In other example, the system 100 may determine that the meal is being used for sales or building client relationships or that the user wants to get a quick meal, and appropriate recommendations are made.

Some of the information determined by the recommendation request module 115 may be provided to the system 100 automatically. For example, the application 142a running on the user device 141a may determine the current geographic location from a geographic positioning system (GPS) or a zip code or address entered by the user. The application 142a may request the user to enter their employee ID and the category of the desired points of interest for which recommendations are being requested. Using the employee ID, the recommendation request module 115 may retrieve the user profile from the recommendation subsystem database 131, and information from the profile, such as employee category, title, employee preferences, etc., can be used to determine the recommendations. Also, the application 142a may present questions to the user to elicit the information described above from the user.

The objective determination module 113 determines one or more objectives for the company or other entity that is related to the desired points of interest. The objectives may be business objectives. The business objectives may be related to and include goals of a company. For example, a company may be focusing on revenue generation, profits and growth. Some related business objectives may include building client relationships, closing sales, recruiting and hiring, team building, cost reduction, and so on. The objectives may be stored in the recommendation subsystem database 131 and different policies for selecting points of interest may be stored and applied for different objectives or different categories of users. Also, the information for points of interests stored in the data repository 130 may categorize the points of interests under specific objectives and categories of users. The recommendation engine 111 determines the business objective and/or a category of a user for a request, and then selects points of interest for the recommendations that are classified under the business objective or category and that comply with policies of the business objective or category if such policies have been implemented and are stored in the data repository. The categories of the users may be responsibility-based, such as project manager, engineer, sales manager, sales associate, support team leader, etc. The categories may be title based, such as associate, manager, senior manager, director, and executive. A user may be classified under one or more categories. Different policies may be applicable to different categories. For example, an executive has a higher spending limit than a director.

The objective determination module 113 selects one or more of the objectives that are applicable to the user, and the recommendation engine 113 may determine the recommendations based on the objectives as described above. The objective determination module 113 may select an objective for a user based on attributes of the user in their profile, the current circumstances and information provided by the user which may specify the objective or other information from which the objective can be determined. For example, the user profile may identify that the user is part of a sales team. Also, the information gathered by the recommendation request module 115 regarding the current circumstances may indicate that the recommendation request is for a client meeting. Based on the information from the user profile and the information regarding the current circumstances, the objective determination module 113 selects building client relationships and closing sales as the business objectives for the request.

The recommendation engine 111 determines recommendations for a request from a user. In one example, the recommendation engine 111 determines the recommendations from one or more of the user profile, current circumstances and environment of the user, a business objective selected by the objective determination module 113, a user category, previous recommendations of other users that are employees of the same company, project associated with the user and policies associated with the user's category or business objective.

The recommendation subsystem database 131 stores points of interest, points of interest descriptions, locations, reviews of the points of interest, employee discounts for the points of interest and other information for the points of interest. In one example, the recommendation engine 111 receives a request from a user for a category of points of interest and identifies the desired points of interest and the current location of the user. From this information, candidate points of interest are identified from the stored points of interest. Policies for the user may be used to filter the candidate points of interest. For example, the points of interest request is for a restaurant. The policies may identify spending limits, whether an employee is required to use points of interest where employee discounts are available, etc. This information is used to filter the candidate recommendations that satisfy the one or more policies. For example, a policy may allow for higher spending limits for the sales team. Also, if the objective is to build client relationships, the recommendations are filtered to identify restaurants that are conducive to this objective, which may be based on information in previous reviews. Also, information about the clients may be used to further filter the recommendations, such as their cuisine preferences. The recommendation presentation module 112 may send the filtered recommendations to the user that sent the recommendation request. Additional details on how the recommendation engine 111 determines the recommendations to present to the user are further described below.

The expense allowance module 116 determines whether the average amount spent by company employees for a points of interest is above, on par with, or below a maximum spending allowance for a particular geographic location and/or for a particular user. An indicator, e.g., a red, yellow, or green indicator may be used to filter the recommendations and may be presented with each recommendation to illustrate whether the average amount spent is above, on par with, or below a maximum spending allowance. This allows the user to quickly find points of interest to select without having to separately read each review and determine average prices, discounts offered, if any, and meal allowance for the geographic location. The expense allowance module 116, for example, calculates an average rating of each of the points of interest based on previous ratings of employees, and calculates an average amount spent for a geographic location and for a category of points of interest and calculates an adjusted average. The adjusted average may be compared against expense allowances for the geographic location to determine the expense allowance indicator indicating whether the adjusted average is above, in par with, or below the expense allowance. The average rating, adjusted average spent and expense allowance indicator may be presented to the user on their device.

The recommendation presentation module 112 sends the recommendations to the user device of the user making the request. In addition to the list of recommended points of interest, the recommendation presentation module 112 may provide other information for each of the points of interest, such as the expense allowance indicator, adjusted average amount spent, etc. The recommendations may include employee reviews for each points of interest. In one example, the user interface 102 may comprise a graphical user interface accessible by the user devices 141a-n via the network 140, and the recommendation presentation module 112 may present the information along with the recommendations to the users via the user interface 102. Also, through the user interface 102, a user can search, for example, by proximity, price, ratings, and reviews provided by their own personal network of employees to identify points of interest.

The behavior action subsystem 120 captures user actions based on the recommendations, and performs analytics on the captured data. The behavior action subsystem 120 may include a behavior action capture module 121, a behavior analytics module 122, a reporting module 123 and an expense management module 124. The behavior action capture module 121 captures and stores information from the users in the data repository 130 about the points of interest that were used. The information may identify a point of interest that was used, the date and the amount spent. The information may include ratings and reviews of the points of interest provided by the user based on their experience. In one example, the behavior action subsystem 120 may present the user with different questions depending on the category of the user and the business objective. For example, if the user is on a sales team, the behavior action subsystem 120 may present questions such as whether the user was with a client, was the point of interest helpful in facilitating a client relationship or a sale, and so on. This information can then be presented to other users that are in the same category or have the same business objective. Different templates may be stored for different categories of users or for different objectives. Each template may include different questions to elicit information specifically pertaining to the category of user that can be helpful to other users in the category for future recommendations.

The expense management module 124 captures expense data related to the points of interest used by the user. For example, the expense management module 124 may interface with an internal system for processing expense data. The expense management module 124 facilitates the entering of expense information by the user, such as amount spent, date, time, etc., and also allows the user to enter comments, for example, if the amount spent exceeds the user's spending limit. The comments may include that the user was paying for multiple employees or that the user was paying for clients or other reasons why the spending limit was exceeded. A display may be generated that requests comments.

The behavior analytics module 122 can slice data, such as amount spent for points of interest, by project, location, level etc. This information may then be used to update policies. Total amount spent for each point of interest may be determined and used to generate vendor relationships, and negotiate rates. Also, the behavior analytics module 122 may determine relationships between points of interest and business objectives based on the captured user actions and reviews. For example, the behavior analytics module 122 may detect patterns from user ratings and reviews and correlate this information with cost savings, business relationship generation, and other goals. These correlations may then be used by the recommendation engine 111 to make future recommendations.

The reporting module 123 can generate reports about spending, vendor quality and other information. Modifiable report templates may be used so the user can customize the reports.

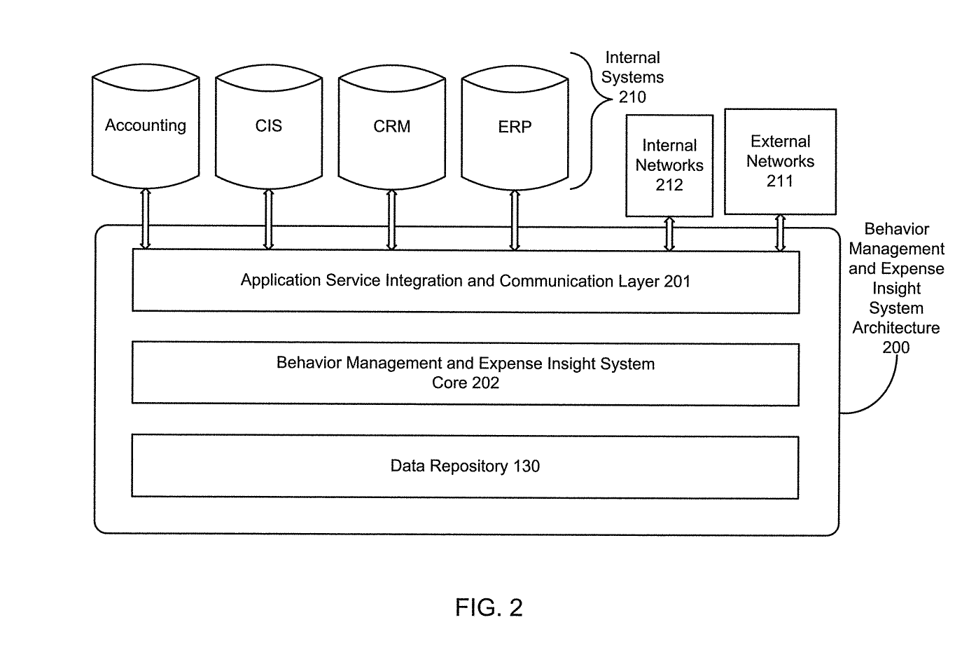

FIG. 2 illustrates an embodiment of a system architecture 200 for the behavior management and expense insight system 100. The system architecture 200 shows that the system 100 may be employed in an enterprise system and connected to internal systems 210 which may include other enterprise systems. The internal systems 210 may include systems for accounting, customer information system (CIS), enterprise resource planning (ERP), customer relationship management (CRM), etc. The system 100 may pull information from the internal systems 210 to update user profiles, determine spending limits, and determine other information. The system 100 may be implemented as software stored on a non-transitory computer readable medium and executed by one or more processors. The architecture 200 may represent a software architecture.

The architecture 200 includes an application service integration and communication layer 201, core 202 and the data repository 130. The layer 201 supports data collection from the internal systems 210. The layer 201 also provides secured access with user devices via external networks 211, such as the Internet, and internal networks 212, which may be internal to the enterprise system. The layer 201 may interface with the internal systems 210 through application program interfaces (APIs) or other interfaces. The layer 201 may also provide a mechanism for secure communication via the internal networks 212 and the external networks 211.

The core 202 performs the functions of the system 100. For example, the core 202 performs the functions of the modules described with respect to FIG. 1. The data repository 130 stores the data for the system 100. The data repository 130 may include a layer for preparing and storing the data in databases in the data repository 130 according to the schemas of the databases.

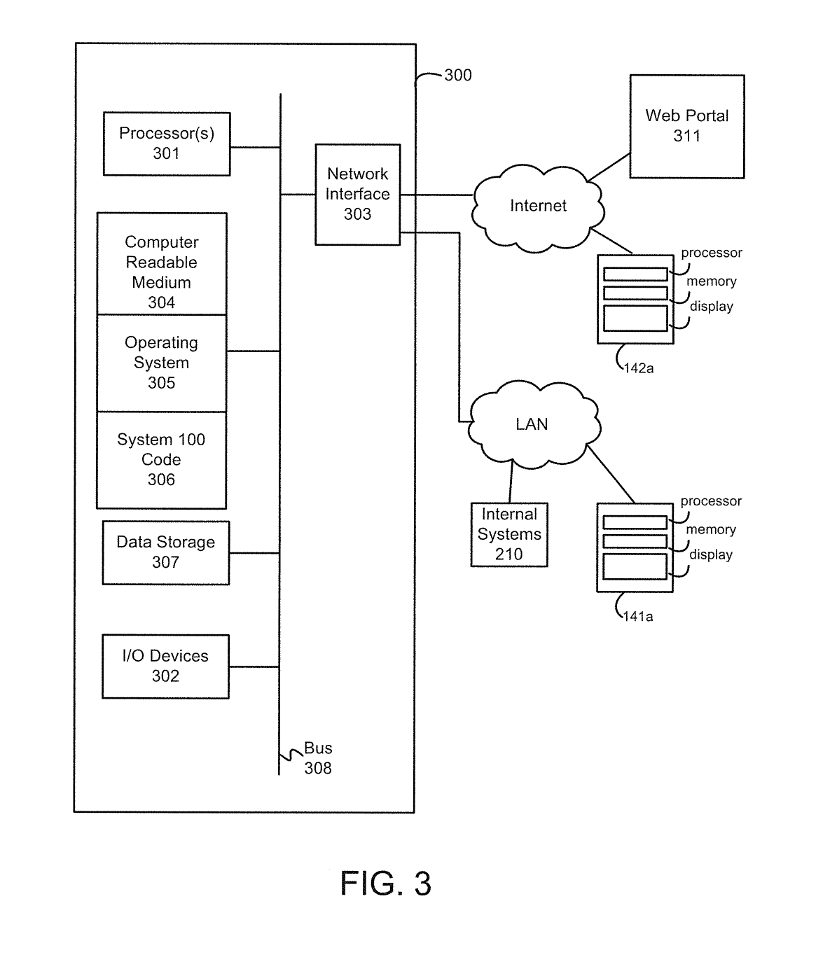

FIG. 3 illustrates a computer system 300 that may be a platform for the system 100. The computer system 300 may represent a server hosting and executing the modules of the system 100. It is understood that the illustration of the computer system 300 is a generalized illustration and that the computer system 300 may include additional components and that some of the components described may be removed and/or modified. Also, the system 300 may be implemented in a distributed computing system, such as a cloud computer system. For example, the computer system 300 may represent a server in a cloud computer system that executes one or more of the functions the system 100.

The computer system 300 includes processor(s) 301, such as a central processing unit, ASIC or other type of processing circuit; input/output devices 302, such as a display, mouse keyboard, etc., a network interface 303, such as a Local Area Network (LAN), a wireless 802.11x LAN, a 3G or 4G mobile WAN or a WiMax WAN, and a computer-readable medium 304. Each of these components may be operatively coupled to a bus 308. The computer readable medium 304 may be any suitable medium which participates in providing instructions to the processor(s) 301 for execution. For example, the computer readable medium 304 may be non-transitory or non-volatile media, such as a magnetic disk or solid-state non-volatile memory or volatile media such as RAM. The instructions stored on the computer readable medium 304 may include machine readable instructions (e.g., code) executed by the processor(s) 301 to perform the methods and functions of the system 100.

The computer readable medium 304 may store an operating system 305, such as MAC OS, MS WINDOWS, UNIX, or LINUX, and code 306 for the system 100. The operating system 305 may be multi-user, multiprocessing, multitasking, multithreading, real-time and the like. The computer system 300 may also host virtual machines that can run the system 100.

The computer system 300 may include a data storage 307, which may include non-volatile data storage. The data storage 307 stores any data used by the system 100. The data storage 307 may be used for the data repository 130 shown in FIG. 1 or the computer system 300 may be connected to a database server (not shown) hosting the data repository 103.

The network interface 303 connects the computer system 300 to the internal systems 210, for example, via a LAN. User devices 141 may connect to the computer system 300 via the network interface 303 via the LAN or the Internet. For example, user device 141a is shown connected via the LAN and user device 141b is shown connected via the Internet. Each user device, for example, includes a processor, memory and/or another type of storage device, a display and/or other input/output devices, and the memory may store the application 142 during runtime. Also, a web portal 311 may be provided for interfacing with the system 100 via the network interface 303.

The following are examples of screen shots that may be generated by the application 142 and/or by the user interface 102. The examples illustrate some of the data that may be captured by the system 100 and information generated by the system 100 based on captured data.

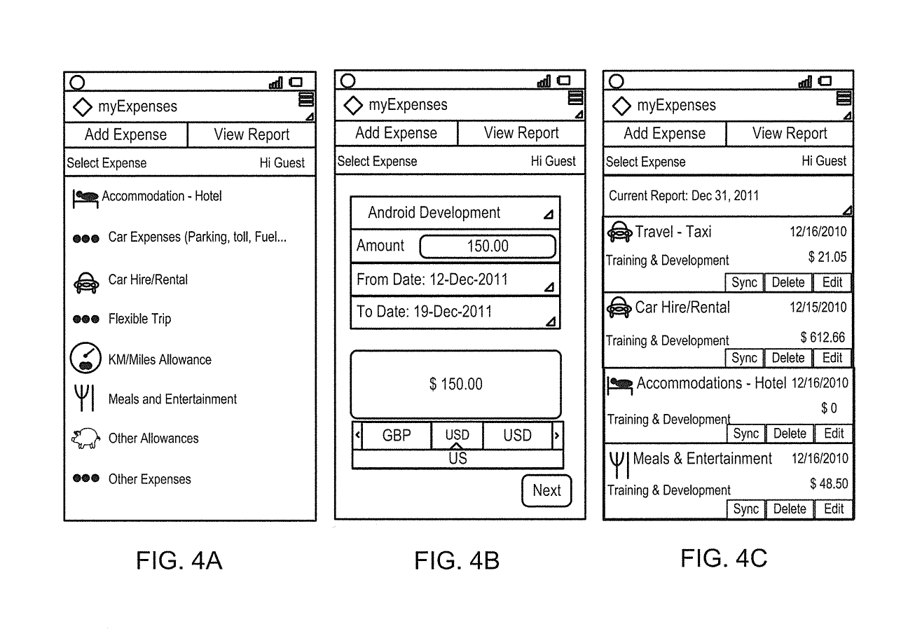

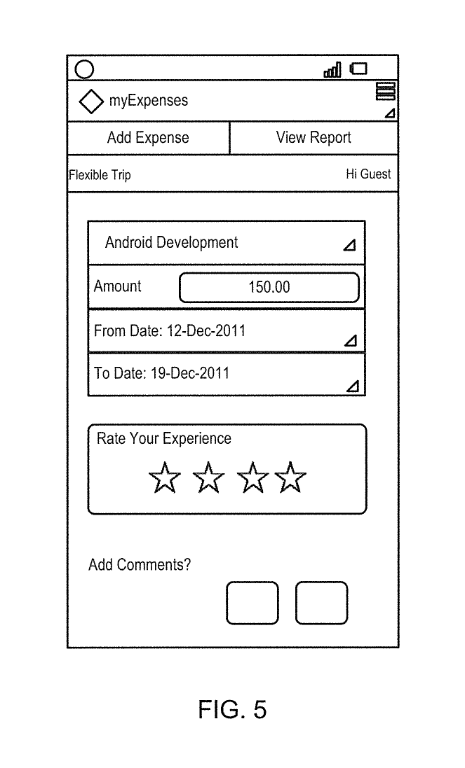

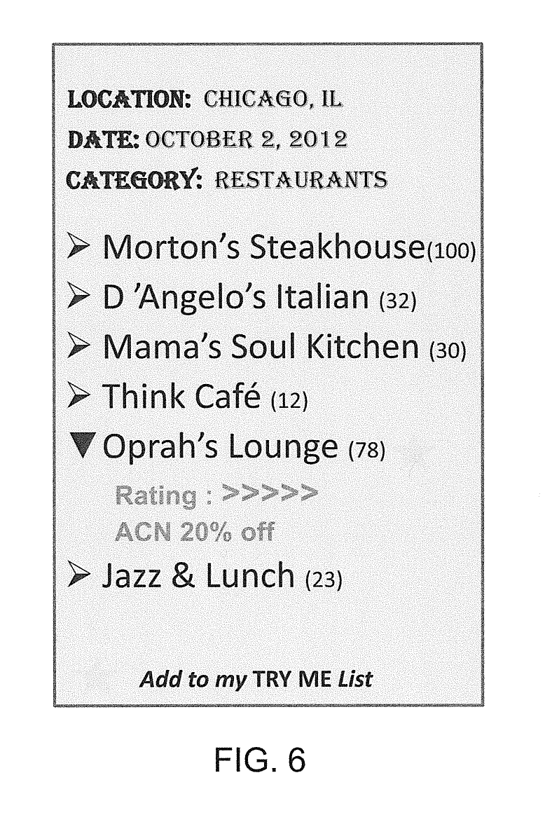

FIGS. 4A-C and 5 show examples of screens that may be used to enter expense data. The screen shots may be viewed on the display of the user devices 141a-n shown in FIGS. 1 and 3. The expense management module 124 shown in FIG. 1 may generate the screens or the screens may be generated through the applications 142a-n. FIG. 4A shows examples of the types of expenses that may be selected and entered, such as accommodation/lodging, car expenses, flexible trip, miles allowance, means and entertainment, other allowances and other expenses. The user may have incurred one or more of these expenses based on recommendations provided by the system 100. For example, the recommendation engine 111 of the system 100 may have provided recommendations for the hotel, meals, etc., and the user may have selected one the recommendations and incurred the expenses. FIG. 4B shows information entered for a “flexible trip” expense, including amount, the from date, the to date, and other information. FIG. 4C shows information that may be presented to the user for their expense report. This screen summarizes the expenses and includes a short description of the reasons for the expense, such as “Training and Development”. From this screen, the user may add, edit or delete expense items and submit the expenses for approval for example by synchronizing the expenses with the company's internal systems.

FIG. 5 shows an example of capturing reviews and comments with expenses for points of interest. For example, the user may enter a rating by number of stars. The expense allowance indicator may be shown, such as red or green. A user can enter additional comments. For example, if the expense is over the user's spending limit, the user may enter comments indicating reasons why the limit was exceeded. The expenses, ratings and comments are stored in the data repository 130.

FIG. 6 shows an example of recommendations, which may be determined by the recommendation engine 111, and displayed to the user, for example, on their user device. In this example, the category of the points of interest is a restaurant. The geographic location, date and category for the recommended points of interest are displayed with the list of recommended restaurants. A user may click on a recommendation to get more information, such as the rating and the discount and reviews, not shown. A “try me” list may be stored for the user and the user can select one or more recommendations to their list to try now or at a later time.

FIG. 7 shows additional information that may be displayed for a recommendation. For example, a user clicks on “Soho Wine and Bar” from the list of recommendations. The address and ratings (e.g., 4.5 out of 5 stars) are shown. Also, a word cloud is shown illustrating the frequency of words in reviews provided by other users of the user's organization that describe the restaurant. The larger the word, the more often it was used in the reviews. The word cloud may be generated by the behavior analytics module 122 and can be used to select recommendations related to the words.

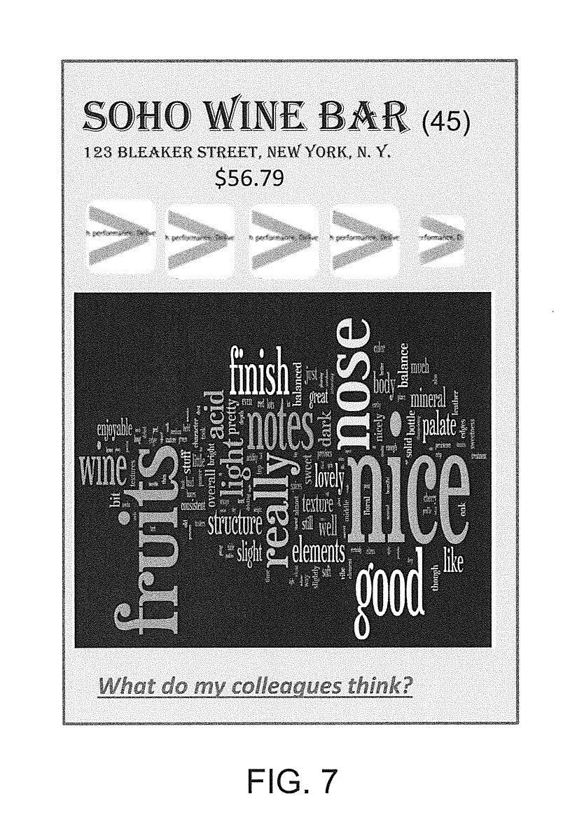

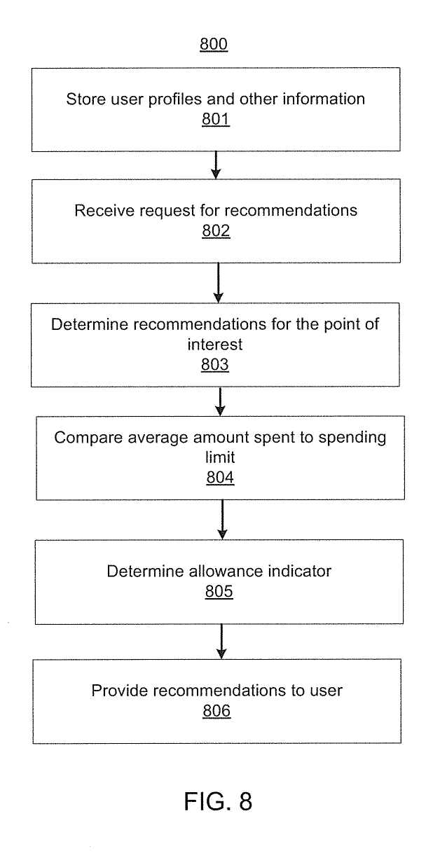

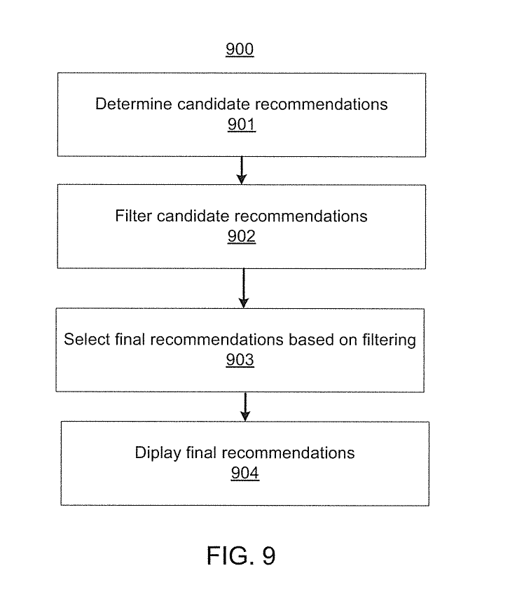

FIG. 8 illustrates a flow chart of a method 800. The method 800 is described with respect to the system 100 shown in FIGS. 1-3 by way of example and the method may be practiced in other systems. A method 900 is also described by way of example with respect to the system 100 and a method 1000 is described by way of example with respect to one of the user devices 141a-n. The methods may be embodied as computer code executable by a processor.

At 801, the system 100 stores profiles for users in a data storage, such as a database in the data repository 130. The users may belong to the same organization. For example, the users are employees of the same company. The system 100 also stores points of interest and information for determining recommendations for the points of interest. For example, the data repository 130 stores a listing of points of interest in many different geographic locations. The points of interest may be initially identified by internal and external systems. Ratings and reviews provided by members of the organization and expense information may be stored along with categories for the points of interest by type, by user category and/or by business objective.

Other information is stored in the data repository, which may be used to select recommendations. For example, the expense allowance module 116 calculates an average amount spent by people from a same organization for each point of interest stored in the data repository 130. The average amount spent is updated as new expense information is received by the system 100. The expense allowance module 116 may adjust the average amount spent based on geographic location. For example, an adjustment multiplier may be determined for a geographic location based on a comparison of expenses to a national average or a comparison of cost of living to national averages. The average amount spent may be multiplied by the adjustment multiplier to determine the adjusted average amount spent for each point of interest.

At 802, the system 100 receives a request for recommendations for a point of interest from a user of the organization. The request may be sent from one of the user devices 141a-n. For example, the request may identify the category of the desired point of interest, such as restaurant, the date and time to use the point of interest, and a geographic location for the point of interest, which may be based on a distance of the user's current location (e.g., within 2 miles) or a general location, such as a city or neighborhood.

At 803, the system 100 determines recommendations for the point of interest based on the category of the point of interest in the request and the geographic location. The recommendations include points of interest identified from the data repository 130 that match the category and the geographic location. The matching may include filtering to further reduce the recommendations matching the category and the geographic location. Various filtering criteria are described below.

At 804, the system 100 compares the average amount spent (which may be the actual average or the average adjusted for the geographic location) for each of the points of interest in the candidate recommendations with the spending limit of the user, which may be assigned by the user's organization. The spending limit may be determined based on information from the user's profile.

At 805, the system 100 determines an allowance indicator based on the comparison. For example, the expense allowance module 116 determines whether the average amount spent for each matching point of interest is above, in par with, or below the spending limit for a user, which may be assigned by the user's organization and which may be based on geographic location. A green, yellow or red indicator may be assigned to each point of interest if its average amount spent is above the spending limit, within a range of the spending limit, or below the spending limit, respectively.

At 806, the system 100 provides the recommendations for the request to the user including the expense allowance indicator for each of the points of interest in the recommendations. The recommendations, for example, are sent to the user device of the user and displayed on the user device.

As described, at 804, the system 100 determines recommendations matching the request. The matching may include filtering. The method 900 describes an embodiment of the matching that includes filtering.

At 901, candidate recommendations are determined for the request. For example, the recommendation engine 111 identifies points of interest stored in the data repository 130 for the category that are in the geographic area or that are within a distance of the user's location. In one example, the system 100 determines a distance a user is willing to travel for higher rated points of interest from ratings and reviews of the points of interest within the geographic location that are stored in the data repository 130. Points of interest may be selected as the candidate recommendations if they are within the determined distance of the user.

At 902, the recommendation engine 111 filters the candidate recommendations. The filtering may include comparing information for the candidate recommendations to criteria and policies to see if they have the criteria and/or whether they are compliant with the policies. The candidate recommendations that have the criteria and/or are compliant with the policies may be selected as the final recommendations to present to the user making the request at 903. At 904, the final recommendations are sent to the user device and are displayed to the user. In one example, only the final recommendations may be sent to the user device and displayed to the user. In another example, only the final recommendations are initially displayed to the user, but the user may request and receive more recommendations that may have been initially filtered out. In yet another example, the recommendations displayed to the user are prioritized. For example, the final recommendations are displayed to the user first and the other candidate recommendations may be displayed lower on the list.

Examples of the filtering of the candidate recommendations performed at 902 are now described and may be used in combination with each other. Filtering may include filtering based on adjusted average amount spent for the points of interest for the candidate recommendations. If they have a red allowance indicator or are a predetermined percentage above the spending limit of the user, they may be filtered out.

In another example, filtering includes determining a business objective from a plurality of different business objectives for the user and/or determining a category from a plurality of different user categories stored in the data repository 130. Then, points of interest for the recommendations are determined based on the user's category or the business objective.

The user's category may be stored in the user's profile. The business objective for a user may be based on the responsibilities of the user in their company. For example, a business objective for a project manager may be team building because it may improve the project work product. A business objective for a sales manager may be to increase sales. Predetermined business objectives may be stored in the data repository 130 and users may be assigned to one or more business objectives based on their roles and responsibilities in the company. The business objectives assigned to a user may be stored in their user profile.

Also, points of interest stored in the data repository 130 may be assigned to a business objective and a user category. Then, the recommendation engine 111 may determine if the candidate recommendations have an assigned business objective or user category that matches the business objective or user category of the user. In one example, the behavior analytics module 122 determines a correlation between points of interest and a business objective and/or a user category. In one example, the correlation is performed using a word cloud for a point of interest, such as the word cloud shown in FIG. 7. For example, a set of words is identified for a business objective from reviews and descriptions of the points of service. If the word cloud for a point of interest identifies one or more of the words with a particular frequency, then the point of interest is assigned to the business objective. A similar analysis may be performed for assigning points of interest to user categories.

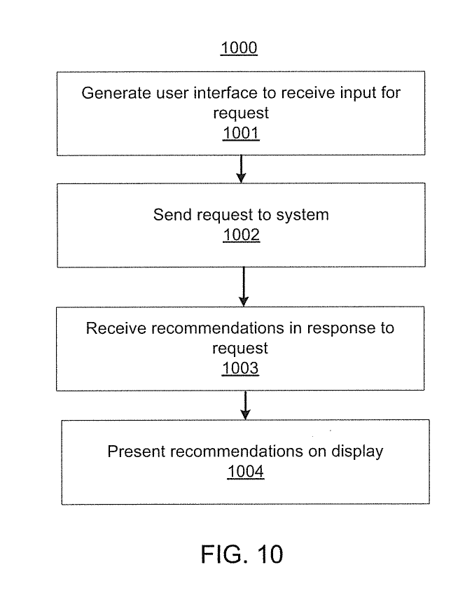

FIG. 10 describes the method 1000 which may be performed by any of the user devices 141a-n shown in FIG. 1. At 1001, a user interface on a display is generated to receive input from a user for a request for recommendations for a point of interest. For example, the user launches the application 142a on the user device 141a and enters information for the request, such as category, data and time, location, user ID, etc.

At 1002, the request is sent to the system 100. At 1003, the user device 141a receives, in response to sending the request, recommendations of points of interest for the request, and each recommendation may include an expense allowance indicator indicating for the user whether an average amount spent at the point of interest for the recommendation is above, in par with, or below a spending limit for the user at the geographic location. At 1004, the recommendations are presented to the user on the display.

While the embodiments have been described with reference to examples, various modifications to the described embodiments may be made without departing from the scope of the claimed embodiments.

What is claimed is:

1. A behavior management and expense insight system comprising:
a data storage to store user profiles of a plurality of users affiliated with a same organization, points of interest, and information for determining recommendations for the points of interest and to store an average amount spent for each point of interest by the plurality of users with a spending limit for each user;
a recommendation request module to receive a request for recommendations for a point of interest from a user of the plurality of users, wherein the request includes a category of the point of interest in the request and a geographic location;
a recommendation engine, executed by a processor, to determine recommendations for the request based on the category and the geographic location for the request;
an expense allowance module to compare the average amount spent for each point of interest in the recommendations with a spending limit for the user determined from the stored user profile for the user and to determine an expense allowance indicator for each point of interest in the recommendations based on the comparisons, wherein the expense allowance indicator indicates whether the average amount spent is above, in par with, or below the spending limit for the user;
a recommendation presentation module to provide the recommendations for the request to the user including the expense allowance indicator for each of the points of interest in the recommendations.

2. The behavior management and expense insight system of claim 1, further comprising:
a behavior action capture module to
receive and store user reviews of the points of interest and expense information including amount spent by each of the users at the points of interest,
determine whether the amount spent for each user exceeds a spending limit for the user, and
if the amount spent exceeds the spending limit, request comments from the user to indicate a reason why the amount spent exceeded the spending limit.

3. The behavior management and expense insight system of claim 1, wherein to select recommendations of points of interest for the request, the recommendation engine is to
determine, from a plurality of business objectives or a plurality of user categories stored in the data storage, a business objective associated with the user or a category of the user based on the stored user profile for the user,
determine policies based on the determined business objective or category, and
identify points of interest from the plurality of points of interest that are compliant with the policies for the recommendations.

4. The behavior management and expense insight system of claim 1, wherein the request for recommendations for the point of interest identify a geographic location, and to select the recommendations of points of interest for the request, the recommendation engine is to
determine from ratings of the points of interest within the geographic location, a distance a user is willing to travel for a higher rated points of interest, and
select the recommendations based on the distance.

5. The behavior management and expense insight system of claim 1, wherein the data storage stores templates for different categories of users, and at least one the templates request information pertaining the user's category and the request from the user, and
the recommendation request module is to request information based on the template for the user's category.

6. The behavior management and expense insight system of claim 1, wherein the recommendation engine is to determine whether the user is bringing a guest from the request, determine preferences of the guest from information in the data storage and to determine the recommendations based on the preferences of the guest.

7. The behavior management and expense insight system of claim 1, wherein the recommendation presentation module is to provide in a first display screen, an average amount spent for each recommendation, a discount offered for the users of the organization, spending limit and rating, wherein the user can click on one of the recommendations in the display screen to view detailed reviews of the point of interest for the recommendation.

8. The behavior management and expense insight system of claim 1, comprising a reporting module to:
plot a time period of amount spent as being above or on par with average spent for a geographic area based on submitted time and expense reports for the geographic area.

9. The behavior management and expense insight system of claim 1, comprising a reporting module to:
determine a group of the users, wherein the group is a group for a client, a project, a category and a performance level; and
report overspending by the group based on submitted time and expense reports for the users in the group.

10. The behavior management and expense insight system of claim 1, wherein the points of interest comprise at least one of restaurants and hotels.

11. A non-transitory computer readable medium including machine readable instructions executable by a processor to:
generate a user interface on a display to receive input from a user for a request for recommendations for a point of interest;
generate the request based on the input and send the request to a behavior management and expense insight system, wherein the request includes a category of a point of interest requested, geographic location, desired time for the point of interest, and user identifier;
receive, in response to sending the request, recommendations of points of interest for the request, and each recommendation includes an expense allowance indicator indicating for the user whether an average amount spent at the point of interest for the recommendation is above, in par with, or below a spending limit for the user at the geographic location; and
present the recommendations on the display.

12. The non-transitory computer readable medium of claim 11, wherein the instructions are to:
receive expense information from the user including amount spent by the user at one of the recommended points of interest; and
if the amount spent exceeds the spending limit, request comments from the user to indicate a reason why the amount spent exceeded the spending limit.

13. The non-transitory computer readable medium of claim 11, wherein the instructions to generate the request include instructions to determine a template of a plurality of templates for different categories of users based on a category of the user, and to use the template to request additional information for generating a review of the point of interest.

14. The non-transitory computer readable medium of claim 11, wherein the instructions to generate the request include instructions to request whether the user is bringing a guest, wherein the recommendations are based on the preferences of the guest. if the input identifies the guest.

15. The non-transitory computer readable medium of claim 11, wherein the instructions are to provide on the display, an average amount spent for each recommendation based on amount spent by users of a same organization, a discount offered for the organization, if available, for each recommendation, the user's spending limit, and rating for each recommendations, wherein the user can click on one of the recommendations in the display screen to view detailed reviews of the point of interest for the recommendation.

16. A non-transitory computer readable medium including machine readable instructions executable by a processor to:
store user profiles of a plurality of users affiliated with a same organization, points of interest, and information for determining recommendations for the points of interest;
store an average amount spent for each point of interest by the plurality of users with a spending limit for each user;
receive a request for recommendations for a point of interest from a user of the plurality of users, wherein the request includes a category of the point of interest in the request and a geographic location;
determine recommendations for the request based on the category and the geographic location for the request;
compare the average amount spent for each point of interest in the recommendations with a spending limit for the user determined from the stored user profile for the user;
determine an expense allowance indicator for each point of interest in the recommendations based on the comparisons, wherein the expense allowance indicator indicates whether the average amount spent is above, in par with, or below the spending limit for the user; and
provide the recommendations for the request to the user including the expense allowance indicator for each of the points of interest in the recommendations.

17. The non-transitory computer readable medium of claim 16, wherein the instructions are to:
receive and store user reviews of the points of interest and expense information including amount spent by each of the users at the points of interest,
determine whether the amount spent for each user exceeds a spending limit for the user, and
if the amount spent exceeds the spending limit, request comments from the user to indicate a reason why the amount spent exceeded the spending limit.

18. The non-transitory computer readable medium of claim 16, wherein the instructions to select recommendations of points of interest for the request are to:
determine, from a plurality of business objectives or a plurality of user categories stored in the data storage, a business objective associated with the user or a category of the user based on the stored user profile for the user;
determine policies based on the determined business objective or category; and
identify points of interest from the plurality of points of interest that are compliant with the policies for the recommendations.

19. The non-transitory computer readable medium of claim 16, wherein the request for recommendations for the point of interest identify a geographic location, and the instructions to select recommendations of points of interest for the request are to:
determine from ratings of the points of interest within the geographic location, a distance a user is willing to travel for a higher rated points of interest, and
select the recommendations based on the distance.

20. The non-transitory computer readable medium of claim 16, wherein the data storage stores templates for different categories of users, and at least one the templates request information pertaining the user's category and the request from the user, and the instructions are to:
request information from the user based on the template for the user's category.
